(19) United States
(12) Patent Application Publication
(10) Pub. No.: US 2016/0082886 A1
(43) Pub. Date: Mar. 24, 2016

(54) APPARATUS FOR ASSISTING BACKWARD DRIVING AND METHOD THEREOF

(71) Applicant: Hyundai Motor Company, Seoul (KR)

(72) Inventor: Dong Hyuk Jeong, Gyeonggi-do (KR)

(21) Appl. No.: 14/683,395

(22) Filed: Apr. 10, 2015

(30) Foreign Application Priority Data
Sep. 24, 2014 (KR) 10-2014-0127420

(51) Int. Cl. B60R 1/00

(52) U.S. Cl. CPC B60R 1/00; B60R 2300/304; B60R 2300/802

(57) ABSTRACT

An apparatus for assisting backward driving of a vehicle includes: a geography detecting sensor be mounted at a rear of the vehicle and configured to obtain rear geographic information; an image sensor configured to obtain an rear image of the vehicle; a backward path calculator configured to calculate a backward path based on the rear geographic information; an image synthesizer configured to synthesize a guideline with the rear image based on the backward path; and a display configured to display the synthesized image. The backward path is calculated to terminate at a limit point rear of the vehicle where it is determined that there is an impeded driving area.

### CROSS-REFERENCE TO RELATED APPLICATION

This application claims the benefit of and priority to Korean Patent Application No. 10-2014-0127420, filed on Sep. 24, 2014 in the Korean Intellectual Property Office, the disclosure of which is incorporated herein in its entirety by reference.

### BACKGROUND

1. Technical Field

The present disclosure relates to an apparatus and method capable of assisting backward driving by generating a steering interlock guideline based on rear geography and obstacle information when reversing the vehicle.

2. Description of the Related Art

In general, a rear-mounted camera in a vehicle enables a driver to safely drive or park backward by providing a rear view of the vehicle. This backward driving assistance system provides a steering interlock guideline that displays a predicted path depending on the steering angle. At this time, if the rear geography of the vehicle is relatively flat, the predicted path is closely matched with the actual path. But if there is a slope or obstacle in the rear of the vehicle, the predicted path can be inaccurate and the existence of the obstacle may not be accurately reflected.

### SUMMARY

In order to solve the above problem of the related art, the present disclosure is provides an apparatus and method capable of assisting backward driving by generating a steering interlock guideline based on rear geography and obstacle information when reversing the vehicle. Also, the present disclosure provides an apparatus and method for assisting backward driving of a vehicle by generating a steering interlock guideline whether there is an area in which driving is impeded by an obstacle, a steeply declining slope, or the like in the rear of the vehicle, and reacting to the said obstacle.

In order to solve the above problem, an apparatus for assisting backward driving of a vehicle according to embodiments of the present disclosure includes: a geography detecting sensor mounted at a rear of the vehicle and configured to obtain rear geographic information; an image sensor configured to obtain an rear image of the vehicle; a backward path calculator configured to calculate a backward path based on the rear geographic information; an image synthesizer configured to synthesize a guideline with the rear image based on the backward path; and a display configured to display the synthesized image. The backward path is calculated to terminate at a limit point rear of the vehicle where it is determined that there is an impeded driving area.

Also, the geography detecting sensor may be implemented by a time of flight (TOF) camera.

Also, the apparatus may further include a steering angle sensor mounted in the vehicle and configured to measure a steering angle.

Also, the backward path calculator may be configured to calculate the backward path based further on the steering angle.

Also, the backward path calculator may be further configured to perform texture mapping of the rear geographic information based on a geography and a lens characteristic of the image sensor.

Furthermore, according to embodiments of the present disclosure, a method for assisting backward driving of a vehicle includes: obtaining rear geographic information and a rear image of the vehicle; calculating a backward path based on the rear geographic information; synthesizing a guideline with the rear image based on the backward path; and displaying the synthesized image. The backward path is calculated to terminate at a limit point rear of the vehicle where it is determined that there is an impeded driving area.

Also, the obtaining of the rear geographic information and the rear image includes: measuring a distance from a TOF camera to a rear land surface of the vehicle; detecting an obstacle using the TOF camera; and acquiring the rear image using an image sensor.

Also, the calculating of the backward path includes: measuring a steering angle using a steering angle sensor; calculating the backward path based further on the steering angle; and generating a guideline based on the backward path.

Also, the method may further include: performing texture mapping of the rear geographic information based on a geography and a lens characteristic of an image sensor.

Furthermore, according to embodiments of the present disclosure, a non-transitory computer readable medium containing program instructions for assisting backward driving of a vehicle includes: program instructions that obtain rear geographic information and a rear image of the vehicle; program instructions that calculate a backward path based on the rear geographic information; program instructions that synthesize a guideline with the rear image based on the backward path; and program instructions that display the synthesized image. The backward path is calculated to terminate at a limit point rear of the vehicle where it is determined that there is an impeded driving area.

Accordingly, the present disclosure can assist the backward driving of a driver by generating a steering interlock guideline based on rear geography and obstacle information when reversing the vehicle. Thus, the driver can easily perform backward driving of the vehicle. Also, the present disclosure can prevent accidents and vehicle damage by identifying a rear obstacle, a steeply declining slope, or the like, and generating a backward path guideline along which safe driving is feasible.

### BRIEF DESCRIPTION OF THE DRAWINGS

The above and other objects, features and advantages of the present disclosure will be more apparent from the following detailed description taken in conjunction with the accompanying drawings, in which:

FIG. 1 is a block diagram showing a configuration of an apparatus for assisting backward drive of a vehicle according to embodiments of the present disclosure.

FIG. 2 is a flow chart showing a method for assisting backward drive of a vehicle according to embodiments of the present disclosure.

FIG. 3 is an exemplary diagram showing a display screen of a guideline if there is an obstacle in the rear of a vehicle according to embodiments of the present disclosure.

FIG. 4 is an exemplary diagram showing a display screen of a guideline if there is a steep slope in the rear of a vehicle according to embodiments of the present disclosure.

### DETAILED DESCRIPTION OF THE EMBODIMENTS

Hereinafter, embodiments of the present disclosure will be explained in detail with reference to the accompanying drawings. As those skilled in the art would realize, the described embodiments may be modified in various different ways, all without departing from the spirit or scope of the present disclosure. Further, throughout the specification, like reference numerals refer to like elements.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

In the present specification, when a certain part “includes” a certain component, as long as there is no opposite description, it means that any other component can be further included, not excluded. In addition, the terms such as “ . . . unit”, “ . . . device”, “module” described in the specification mean a unit that processes at least one function or operation, and it can be implemented in hardware or software, or a combination of hardware and software. Further, the article such as the “one”, “a” and “the” and the like, can be used as a meaning including both the singular and the plural, unless it is differently indicated in the context of describing the present disclosure or obviously countered by the context.

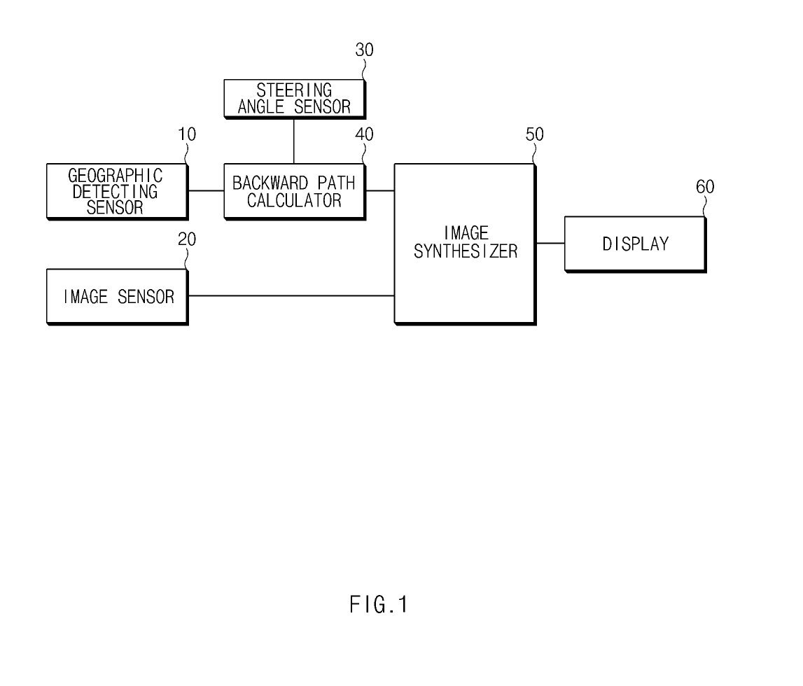

FIG. 1 is a block diagram showing a configuration of an apparatus for assisting backward drive of a vehicle according to embodiments of the present disclosure. According to FIG. 1, an apparatus for assisting a driver includes a geography detecting sensor 10 (e.g., geographic detecting sensor 10 in FIG. 1), an image sensor 20, a steering angle sensor 30, a backward path calculator 40, an image synthesizer 50 and a display 60.

The geography detecting sensor 10 is mounted at the rear of the vehicle and detects the rear geography. The geography detecting sensor 10 measures the distance between the sensor position and the rear land surface and the obstacle. The geography detecting sensor 10 is implemented by a time of flight (TOF) camera which measures a number of distances once.

The image sensor 20 is installed in the rear of the vehicle, adjacent to the geography detecting sensor 10 and takes a rear image. The image sensor 20 can be implemented by a charge couple device (CCD) image sensor, a charge priming device (CPD) image sensor, a metal oxide semiconductor (MOS) image sensor, a complementary MOS (CMOS) image sensor, or the like.

The image sensor 20 stores lens characteristic information in a built-in memory (not shown) and manages it. For the purposes of the present disclosure, it is described that the lens characteristic information of the image sensor 20 is stored and managed in the memory mounted in the image sensor 20, but it may be implemented so that the lens characteristic information of the image sensor 20 is stored and managed in the memory disposed outside the image sensor 20.

The steering angle sensor 30 is installed on a steering column switch cluster and measures the rotation angle of the steering wheel. That is, the steering angle sensor 30 measures the steering angle of the vehicle.

The backward path calculator 40 calculates the backward path based on the rear geographic information and/or the steering angle. At this time, the backward path calculator 40 performs texture mapping of the rear geographic information measured by the geography detecting sensor 10 with the geography depending on a lens characteristic of the image sensor 20. In other words, the backward path calculator 40 maps the rear geographic information with the geography depending on the lens characteristic of the image sensor 20 and calculates the predicted backward path depending on the steering angle. Also, the backward path calculator 40 generates a guideline image (i.e., guideline) based on the calculated backward path. Also, if there is the area which driving is impeded, e.g., due to an obstacle or a steeply declining slope, etc., in the rear of the vehicle, the backward path calculator 40 calculates the backward path to a limit point at which the vehicle can move backward and generates the guideline. That is, the backward path is calculated to terminate at a limit point rear of the vehicle where it is determined that there is an impeded driving area (e.g., due to an obstacle or a steeply declining slope, etc.).

The image synthesizer 50 synthesizes the rear image obtained using the image sensor 20 and the guideline image outputted from the backward path calculator 40. The image synthesizer 50 is implemented by an image processor.

The display 60 displays the synthesized image outputted from the image synthesizer 50 when reversing the vehicle. The display 60 also displays the data, such as the vehicle's progress and the like, according to the operation of the apparatus for assisting the backward driving of the vehicle. The display 60 can include at least one of a liquid crystal display (LCD), a thin film transistor-LCD (TFT LCD), an organic light-emitting diode (OLED), a flexible display, a three-dimensional (3D) display, a transparent display, a head-up display (HUD), and a touch screen.

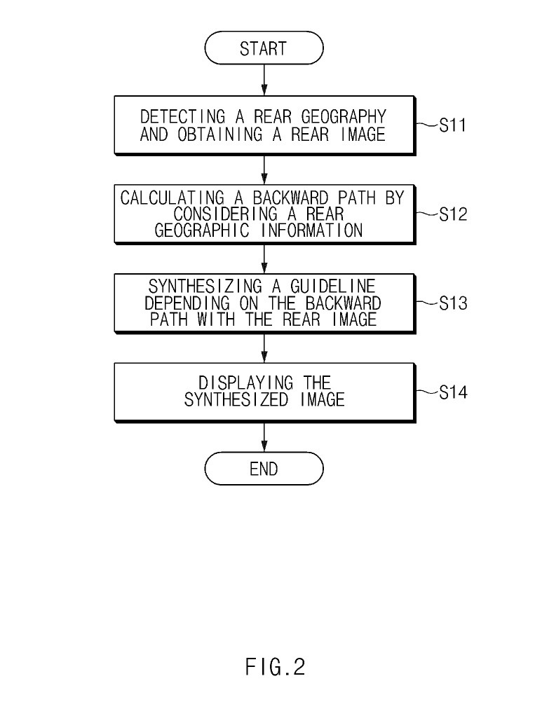

FIG. 2 is a flow chart showing a method for assisting backward drive of a vehicle according to embodiments of the present disclosure. Referring to FIG. 2, an apparatus for assisting backward driving of a vehicle obtains the rear geographic information and the rear image of the vehicle through the geography detecting sensor 10 and the image sensor 20 (S11). Here, the geography detecting sensor 10 measures the distance from the sensor to the rear land surface and/or an obstacle.

The backward path calculator 40 of the apparatus for assisting backward driving calculates the backward path using the rear geographic information, the steering angle measured through the steering angle sensor 30, and the lens characteristic of the image sensor 20 (S12). The backward path calculator 40 calculates the predicted backward path depending on the steering angle after texture mapping the rear geographic information with the geography depending on the lens characteristic of the image sensor 20. And, the backward path calculator 40 generates the steering interlock guideline based on the calculated backward path.

The image synthesizer 50 of the apparatus for assisting backward drive synthesizes the guideline depending on the backward path outputted from the backward path calculator 40 and the rear image outputted from the image sensor 20 (S13).

The display 60 displays the synthesized image outputted from the image synthesizer 50 (S14).

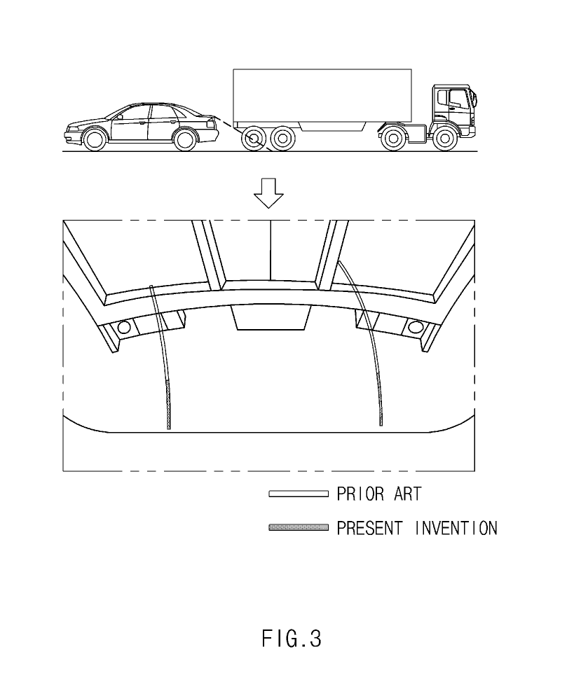

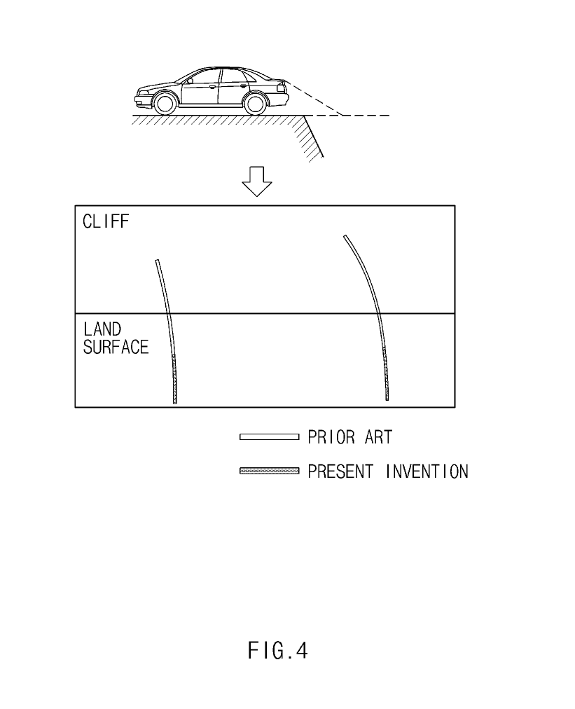

FIG. 3 is an exemplary diagram showing a display screen of a guideline if there is an obstacle in the rear of a vehicle according to embodiments of the present disclosure, and FIG. 4 is an exemplary diagram showing a display screen of a guideline if there is a steep slope in the rear of a vehicle according to embodiments of the present disclosure. Referring to FIG. 3 and FIG. 4, if there is an obstacle or a steep slope in the rear of the vehicle (e.g., a cliff), the apparatus for assisting backward driving displays the guideline only to the limit point at which the vehicle can move backward (e.g., before contacting the impedance).

Embodiments according to the present disclosure may be implemented by various means, for example, hardware, firmware, software, or a combination of them and the like. In the case of hardware implementations, embodiments of the present disclosure may be implemented by one or more application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, and the like.

In the case of the implementation by firmware or software, embodiments of the present disclosure may be implemented in the form of a module for performing the above described functions or operations, procedures, functions and the like. Software codes may be stored in a memory unit and may be driven by a processor. The memory unit is located inside or outside the processor, and the data may be exchanged with the processor by various known means.

Furthermore, the techniques described herein may be embodied as non-transitory computer readable media on a computer readable medium containing executable program instructions executed by a processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

It is apparent to those skilled in the art that the present disclosure may be embodied in other specific forms without departing from the features of the present disclosure. Thus, the above-mentioned detailed description must not be interpreted as restrictive and it must be considered as an example. The scope of the present disclosure should be defined by the reasonable interpretation of the appended claims, and all the changes within the equivalent scope are included in the scope of the present disclosure.

What is claimed is:

1. An apparatus for assisting backward driving of a vehicle comprising:
a geography detecting sensor mounted at a rear of the vehicle and configured to obtain rear geographic information;
an image sensor configured to obtain an rear image of the vehicle;
a backward path calculator configured to calculate a backward path based on the rear geographic information;
an image synthesizer configured to synthesize a guideline with the rear image based on the backward path; and
a display configured to display the synthesized image,
wherein the backward path is calculated to terminate at a limit point rear of the vehicle where it is determined that there is an impeded driving area.

2. The apparatus according to claim 1, wherein the geography detecting sensor is implemented by a time of flight (TOF) camera.

3. The apparatus according to claim 1, further comprising:
a steering angle sensor mounted in the vehicle and configured to measure a steering angle.

4. The apparatus according to claim 3, wherein the backward path calculator is configured to calculate the backward path based further on the steering angle.

5. The apparatus according to claim 1, wherein the backward path calculator is further configured to perform texture mapping of the rear geographic information based on a geography and a lens characteristic of the image sensor.

6. A method for assisting backward driving of a vehicle comprising:
obtaining rear geographic information and a rear image of the vehicle;
calculating a backward path based on the rear geographic information;
synthesizing a guideline with the rear image based on the backward path; and
displaying the synthesized image,
wherein the backward path is calculated to terminate at a limit point rear of the vehicle where it is determined that there is an impeded driving area.

7. The method according to claim 6, wherein the obtaining of the rear geographic information and the rear image comprises:
measuring a distance from a TOF camera to a rear land surface of the vehicle;
detecting an obstacle using the ToF camera; and
acquiring the rear image using an image sensor.

8. The method according to claim 6, wherein the calculating of the backward path comprises:
measuring a steering angle using a steering angle sensor;
calculating the backward path based further on the steering angle; and
generating a guideline based on the backward path.

9. The method according to claim 6, further comprising:
performing texture mapping of the rear geographic information based on a geography and a lens characteristic of an image sensor.

10. A non-transitory computer readable medium containing program instructions for assisting backward driving of a vehicle, the computer readable medium comprising:
program instructions that obtain rear geographic information and a rear image of the vehicle;
program instructions that calculate a backward path based on the rear geographic information;
program instructions that synthesize a guideline with the rear image based on the backward path; and
program instructions that display the synthesized image,
wherein the backward path is calculated to terminate at a limit point rear of the vehicle where it is determined that there is an impeded driving area.
